(19) United States
(12) Patent Application Publication
(10) Pub. No.: US 2012/0080541 A1
(43) Pub. Date: Apr. 5, 2012

(54) NOZZLE CLOSURE DEVICE FOR A PAINT SPRAYER

(76) Inventor: John W. Schnell, Anderson, SC (US)

(21) Appl. No.: 13/252,798

(22) Filed: Oct. 4, 2011

Related U.S. Application Data
(60) Provisional application No. 61/389,605, filed on Oct. 4, 2010.

(51) Int. Cl. B05B 9/01; B05B 1/30

(52) U.S. Cl. 239/526; 239/569; 222/494

(57) ABSTRACT

A nozzle assembly for use with a paint sprayer that includes a reservoir configured to store a supply of liquid and a pump operable to draw liquid from the reservoir. The nozzle assembly includes a nozzle configured to receive liquid under pressure from the pump and operable to spray the liquid onto a surface, and a nozzle closure device that is movable between an open position, in which liquid is sprayed out of the nozzle generally unimpinged, and a closed position, in which the nozzle closure device covers the nozzle. The nozzle closure device is moved from the closed position to the open position by a force other than the liquid under pressure from the pump.

### CROSS-REFERENCE TO RELATED APPLICATIONS

This application claims priority to U.S. Provisional Patent Application No. 61/389,605, filed Oct. 4, 2010, the entire contents of which are incorporated by reference herein.

### BACKGROUND

The invention relates to paint sprayers and, more particularly, to nozzle closure devices for paint sprayers.

Paint sprayers have the advantage of providing users with the ability to conveniently spray paint, glue, texture, or other liquids and partial liquids. A disadvantage of current paint sprayers is that after a user stops spraying, spray liquid can cure and harden in and around the spray nozzle. When the paint sprayer is used again, the nozzle can be blocked, partially blocked, or the cured spray liquid can be expelled from the nozzle onto the work piece, ruining the finish of the work piece. Another disadvantage of current paint sprayers is that the nozzles of the sprayers need to be cleaned to remove the buildup of cured spray liquid.

### SUMMARY

In one embodiment, the invention provides a nozzle assembly for use with a paint sprayer. The paint sprayer includes a reservoir configured to store a supply of liquid and a pump operable to draw liquid from the reservoir. The nozzle assembly includes a nozzle configured to receive liquid under pressure from the pump and operable to spray the liquid onto a surface, and a nozzle closure device that is movable between an open position, in which liquid is sprayed out of the nozzle generally unimpinged, and a closed position, in which the nozzle closure device covers the nozzle. The nozzle closure device is moved from the closed position to the open position by a force other than the liquid under pressure from the pump.

In another embodiment, the invention provides a paint sprayer including a body, a nozzle supported by the body for spraying liquid onto a surface, a reservoir configured to store a supply of liquid, a pump operable to draw liquid from the reservoir and direct the liquid under pressure to the nozzle, and a nozzle closure device coupled to the body adjacent the nozzle. The nozzle closure device is movable between an open position, in which liquid is sprayed out of the nozzle generally unimpinged, and a closed position, in which the nozzle closure device covers the nozzle. The nozzle closure device is moved from the closed position to the open position by a force other than the liquid under pressure from the pump.

Other aspects of the invention will become apparent by consideration of the description and accompanying drawings.

### BRIEF DESCRIPTION OF THE DRAWINGS

FIG. 1 is a perspective view of a paint sprayer including a nozzle assembly and tip guard.

FIG. 2A is a front view of the nozzle assembly and tip guard shown in FIG. 1, the nozzle assembly including an embodiment of a nozzle closure device in an open position.

FIG. 2B is a perspective view of the nozzle closure device shown in FIG. 2A in a closed position.

FIG. 2C is a perspective view of the nozzle closure device shown in FIG. 2A in the open position.

FIG. 3 is a front view of the nozzle assembly and tip guard shown in FIG. 2A with the nozzle closure device in the closed position.

FIG. 4 is a perspective view of a portion of the paint sprayer shown in FIG. 1, the paint sprayer including an actuator mechanism to actuate the nozzle closure device.

FIG. 5 is a side view of a portion of the paint sprayer and the actuator mechanism shown in FIG. 4.

FIG. 6 is a front perspective view of a portion of the paint sprayer and the actuator mechanism shown in FIG. 4.

FIG. 7 is a front view of the nozzle assembly and tip guard shown in FIG. 1, the nozzle assembly including another embodiment of a nozzle closure device in an open position.

FIG. 8 is a front view of the nozzle assembly and tip guard shown in FIG. 7 with the nozzle closure device in a closed position.

FIG. 9 is a front view of the nozzle assembly and tip guard shown in FIG. 1, the nozzle assembly including another embodiment of a nozzle closure device in an open position.

FIG. 10 is a front view of the nozzle assembly and tip guard shown in FIG. 9 with the nozzle closure device in a closed position.

FIG. 11 is a perspective view of the nozzle assembly and tip guard shown in FIG. 1, the nozzle assembly including another embodiment of a nozzle closure device in an open position.

FIG. 12 is a perspective view of the nozzle assembly and tip guard shown in FIG. 11 with the nozzle closure device in a closed position.

FIG. 13 is a cross-sectional view of the nozzle assembly and tip guard shown in FIG. 11 with the nozzle closure device in the open position.

FIG. 14 is a perspective view of the nozzle assembly and tip guard shown in FIG. 1, the nozzle assembly including another embodiment of a nozzle closure device in an open position.

FIG. 15 is a cross-sectional view of the nozzle assembly and tip guard shown in FIG. 14 with the nozzle closure device in a closed position.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

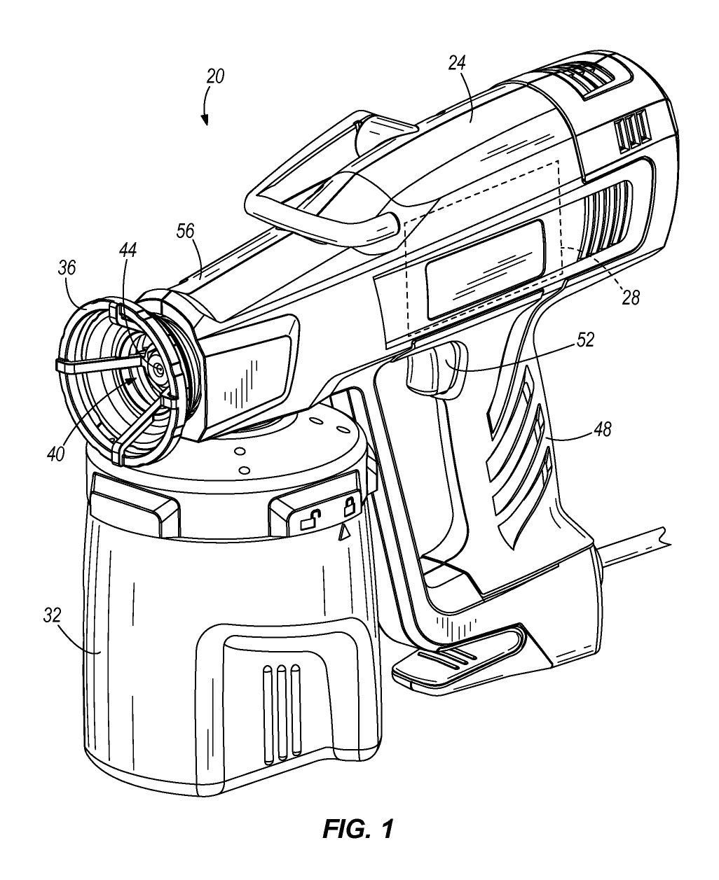

FIG. 1 illustrates a paint sprayer 20 for spraying paint or other curing liquids (e.g., glue, stain, varnish, texture, etc.) or semi-liquids onto a surface or work piece. The illustrated paint sprayer 20 includes a body 24, a pump 28, a reservoir 32, a tip guard 36, and a nozzle assembly 40 including a nozzle 44. The body 24 includes a handle 48 to facilitate grasping and holding the paint sprayer 20 during operation. A trigger 52 is supported by the body 24 adjacent the handle 52 to control operation of the sprayer 20. The tip guard 36 and the nozzle assembly 40 are coupled to a forward, or nose, portion 56 of the body 24.

The pump 28 and the reservoir 32 are supported by the body 24 such that the illustrated paint sprayer 20 is a hand-held tool. The pump 28 is enclosed in the body 20 and is activated when a user actuates (e.g., pulls) the trigger 52. The reservoir 32 is configured to store a supply of liquid (e.g., paint). In the illustrated embodiment, the reservoir 32 is threadably coupled to the forward portion 56 of the body 24 to facilitate removing and refilling the reservoir 32 with liquid. In other embodiments, the pump 28 and/or the reservoir 32 may be separate from the body 24 of the paint sprayer 20. In such embodiments, the reservoir 32 may include a tube that connects the pump 28 to a remote reservoir or source of liquid.

In operation, the pump 28 draws liquid from the reservoir 32 and directs the liquid under pressure to the nozzle 44. The nozzle 44 receives the liquid from the pump 28 and sprays the liquid onto a work piece. In the illustrated embodiment, the paint sprayer 20 is a corded tool such that the pump 28 is powered by a wall outlet or generator. In other embodiments, the paint sprayer 20 may include a battery pack, such as a Li-ion or NiCad power tool battery pack, to power the pump 28.

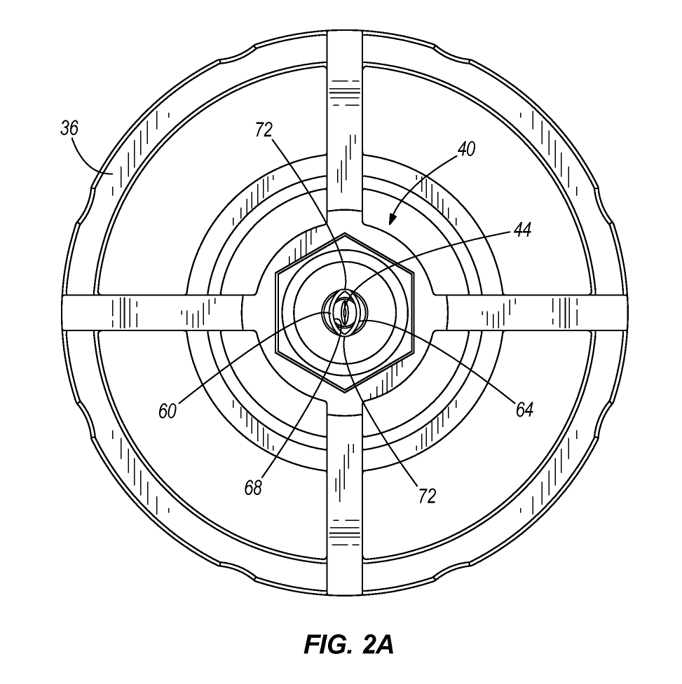

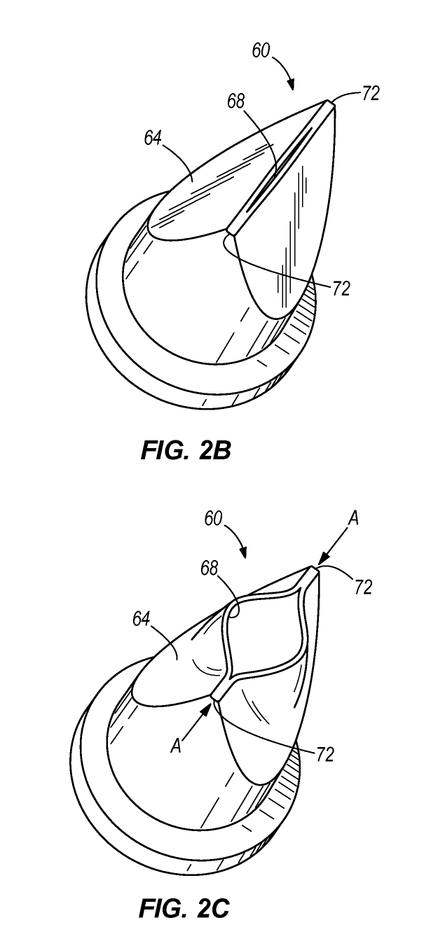

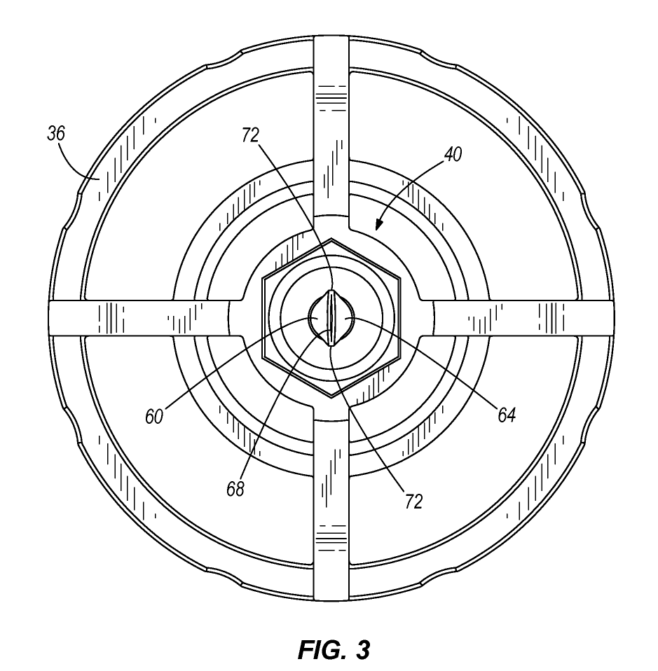

As shown in FIGS. 2A-3, the nozzle assembly 40 also includes a nozzle closure device 60. The illustrated nozzle closure device 60 includes an elastomeric duckbill valve 64 coupled to an exterior surface of the forward portion 56 of the body 24 adjacent the nozzle 44. The duckbill valve 64 is movable between an open position (FIGS. 2A and 2C) and a closed position (FIGS. 2B and 3) without removing the valve 64 from the body 24 of the paint sprayer 20. The duckbill valve 64 defines a slit 68 extending between ends of a wide portion 72 of the valve 64. Compressing or squeezing the duckbill valve 64 along the wide portion 72 (i.e., in the direction of arrows A (FIG. 2C)) opens the slit 68 to move the duckbill valve 64 from the closed position to the open position. The natural resilience of the duckbill valve 64 biases the valve 64 toward the closed position when the compression force is removed.

When in the open position (FIG. 2A), the duckbill valve 64 allows liquid to be sprayed out of the nozzle 44 generally unimpinged. That is, when opened, the valve 64 does not interfere with the shape/pattern or volume of liquid being sprayed from the nozzle 44 during operation of the paint sprayer 20. When in the closed position (FIG. 3), the duckbill bill valve 64 covers the nozzle 44, inhibiting paint from spraying out of the nozzle assembly 40 and inhibiting air from passing through the valve 64 to the nozzle 44. By inhibiting air from reaching and entering the nozzle 44, the valve 64 inhibits liquid from curing in and around the nozzle 44 and thereby blocking the nozzle 44 during a subsequent use.

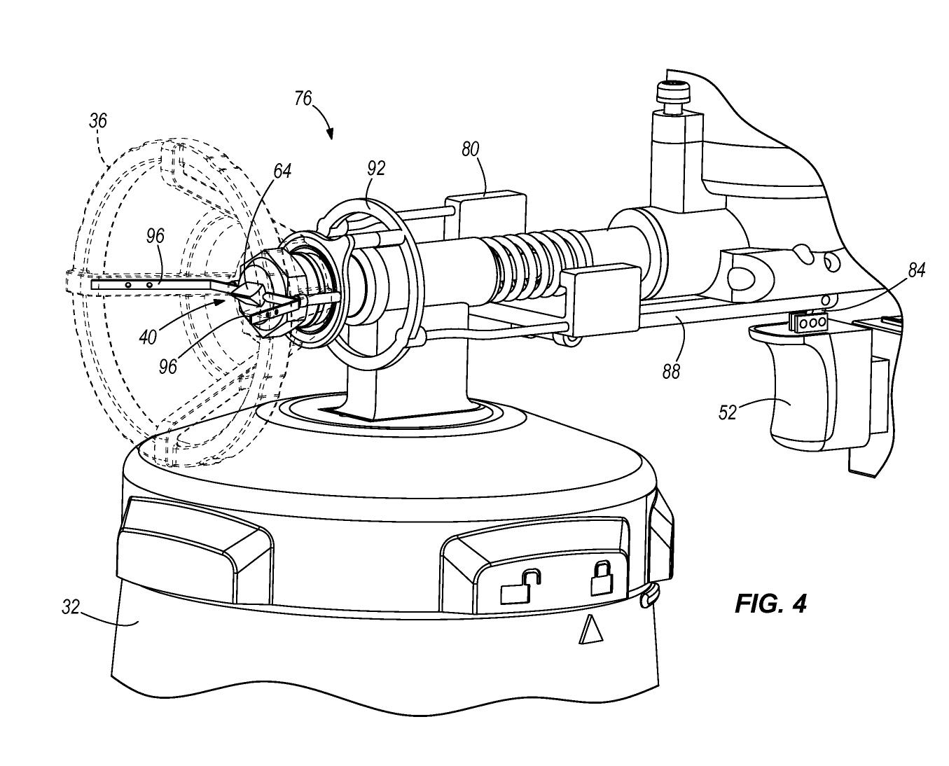

Referring to FIGS. 4-6, the duckbill valve 64 is moved to the open position by an actuator mechanism 76. In the illustrated embodiment, the actuator mechanism 76 includes a linkage 80 coupled to the trigger 52 to open the duckbill valve 64 when the trigger 52 is actuated. The linkage 80 pinches the duckbill valve 64 along the wide portion 72 to move the valve 64 toward the open position. The duckbill valve 64 is thereby moved to the open position by a force other than the liquid being supplied under pressure from the pump 28 to the nozzle 44. Such an arrangement reduces the possibility of the nozzle assembly 40 discharging an uneven or uncontrolled spray pattern when the paint sprayer 20 is initially activated. In other embodiments, the actuator mechanism 76 may include other types of structures or mechanisms to open and/or close the duckbill valve 64.

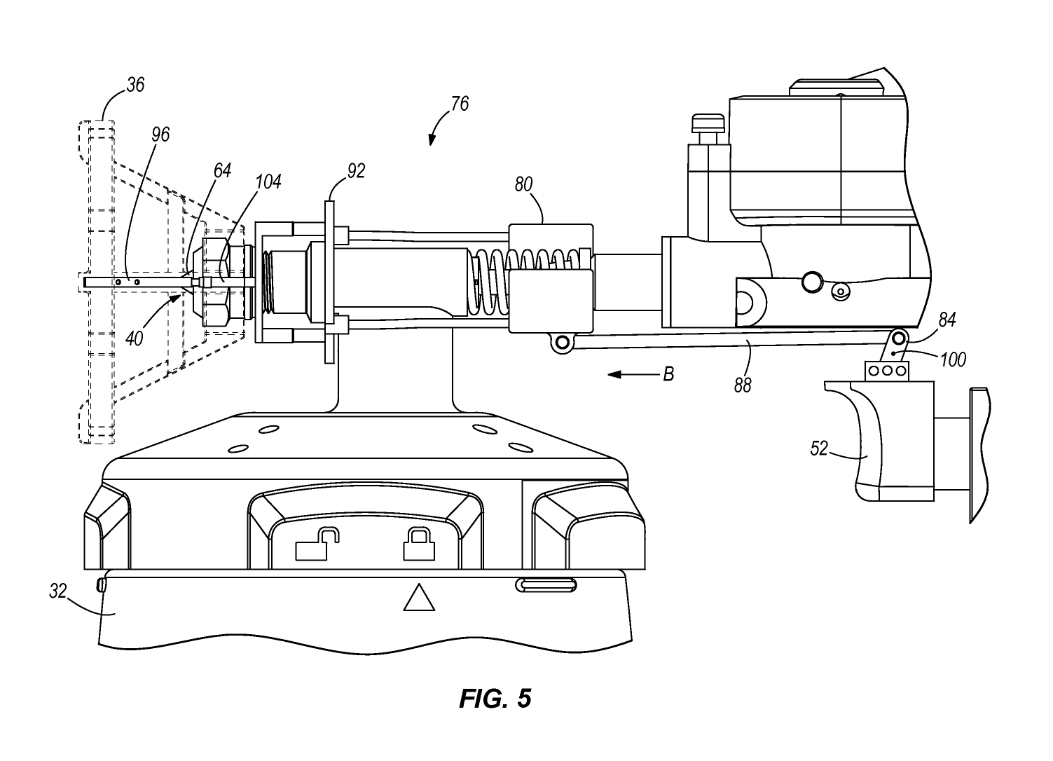

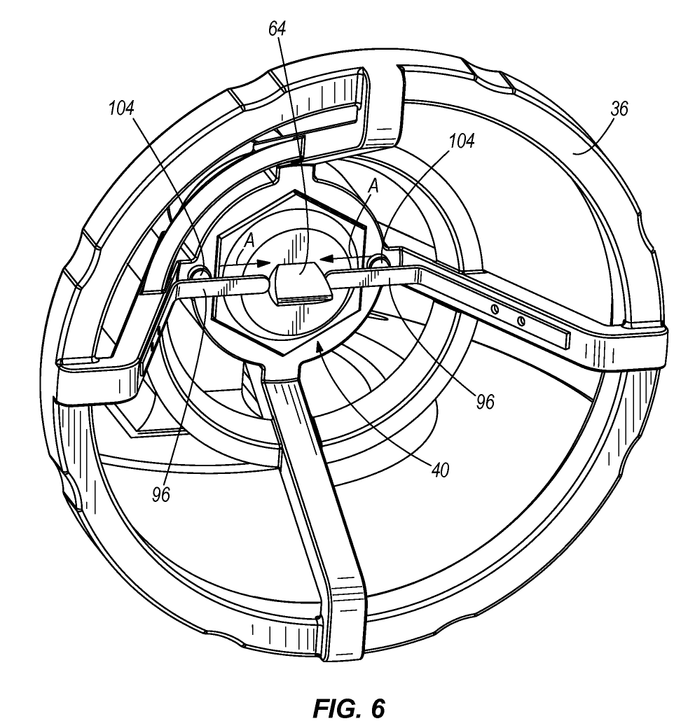

The illustrated linkage 80 includes a pivot arm 84, a connecting arm 88, a connecting hub 92, and two fingers 96. The pivot arm 84 is coupled to the trigger 52 and pinned to the body 24 of the paint sprayer 20 at a pivot point 100 (FIG. 5). The connecting arm 88 is pivotally coupled to the pivot arm 84 and extends between the pivot arm 84 and the connecting hub 92. The connecting hub 92 includes two pins 104 extending through openings in the tip guard 36. The fingers 96 are coupled to the tip guard 36 and bent to generally follow the contour of the inner surface of the guard 36. In some embodiments, such as the illustrated embodiment, the fingers 96 may be composed of spring steel to facilitate bending the fingers 96 during operation.

When the trigger 52 is actuated, the trigger 52 pivots the pivot arm 84 about the pivot point 100, which pushes the connecting arm 88 toward the tip guard 36 of the paint sprayer 20 (i.e., in the direction of arrow B (FIG. 5)). The connecting arm 88 pushes the connecting hub 92 and the pins 104 toward the tip guard 36. As the pins 104 move through the tip guard 36, the pins 104 engage portions of the fingers 96. The fingers 96 are thereby moved in the direction of arrows A (FIG. 6) to squeeze and open the duckbill valve 64. When the trigger 52 is released, the pivot arm 84 is pivoted back about the pivot point 100, pulling the connecting arm 88 and the connecting hub 92 away from the fingers 96 such that the fingers 96 disengage the duckbill valve 64. In the illustrated embodiment, the fingers 96 are composed of a resilient material to automatically spring back away from the duckbill valve 64 when the pins 104 disengage the fingers 96. The duckbill valve 64 can then move back to the closed position due to the resilience of the elastomeric material.

Actuating the trigger 52 also activates the pump 28 of the paint sprayer 20 to spray liquid from the nozzle 44. The trigger 52 thereby simultaneously actuates the duckbill valve 64 and the pump 28 to move the valve 64 toward the open position and to spray liquid from the nozzle 44. When the trigger 52 is released, the paint sprayer 20 ceases to spray liquid from the nozzle 44 and the linkage 80 allows the duckbill valve 64 to close to inhibit liquid from curing in and around the nozzle 44.

In some embodiments, the paint sprayer 20 may be designed to open the duckbill valve 64 a short time (e.g., less than about one second) before the pump 28 is activated and to close the duckbill valve 64 a short time (e.g., less than about one second) after the pump 28 is deactivated. For example, actuating the trigger 52 a small amount may actuate the linkage 80 to open the valve 64 before the pump 28 is activated. The pump 28 may then be activated when the trigger 52 is fully actuated. Likewise, when the trigger 52 is released a small amount, the pump 28 may be immediately deactivated. The linkage 80, however, may maintain the duckbill valve 64 in the open position until the trigger 52 is completely released. Such a configuration may help reduce interference of the duckbill valve 64 with liquid being sprayed from the nozzle 44. In other embodiments, the paint sprayer 20 may include separate triggers, or other user-engageable actuators, for the pump 28 and the actuator mechanism 76.

In other embodiments, the nozzle closure device 60 can be coupled to the tip guard 36 or another portion of the paint sprayer 20, rather than directly to the body 24 of the paint sprayer 20. Additionally or alternatively, the duckbill valve 64 may be actively closed by the linkage 80 instead of relying on the natural resilience of the elastomeric material of the valve 64. In still other embodiments, the duckbill valve 64 may be closed by a spring or another mechanism of the paint sprayer 20.

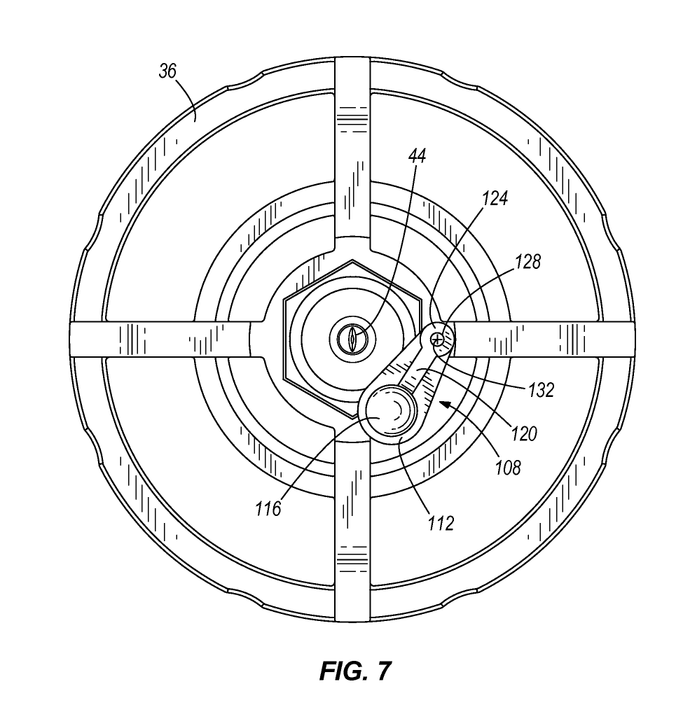

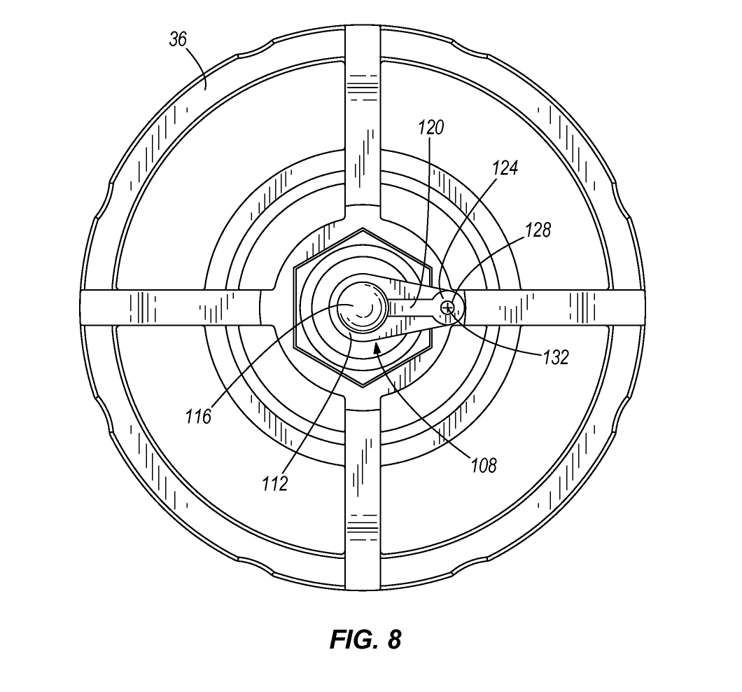

FIGS. 7 and 8 illustrate another nozzle closure device 108 that is suitable for use with the paint sprayer 20. The illustrated nozzle closure device 108 includes a pivot arm 112 having a sealing portion 116, an intermediate portion 120, and an attachment portion 124. The sealing portion 116 is shaped and sized to selectively cover the nozzle 44. A pin 128 extends through the attachment portion 124 to pivotally couple the pivot arm 112 to the tip guard 36. The arm 112 is thereby pivotable about an axis 132 defined by the pin 128 relative to the nozzle 44 between an open position (FIG. 7) and a closed position (FIG. 8) without removing the arm 112 from the tip guard 36.

When in the open position, the pivot arm 112 is pivoted about the axis 132 until the sealing portion 116 and the intermediate portion 120 are sufficiently spaced apart from the nozzle 44 so that the arm 112 does not impinge on liquid being sprayed from the nozzle 44. When in the closed position, the pivot arm 112 is pivoted about the axis 132 until the sealing portion 116 is positioned over the nozzle 44 to cover the nozzle 44. In this position, the pivot arm 112 inhibits air from entering the nozzle 44 and curing liquid in and around the nozzle 44.

In the illustrated embodiment, the pivot arm 112 is manually pivoted between the open position and the closed position. During use, a user manually pivots the arm 112 to the open position and then operates the paint sprayer 20 by actuating the trigger 52. When finished, the user manually pivots the arm 112 to the closed position to cover the nozzle 44. In other embodiments, the pivot arm 112 may be pivoted between the open position and the closed position automatically. For example, in some embodiments, the trigger 52 may cause the pivot arm 112 to move between the positions. In such embodiments, the pivot arm 112 may be moved by mechanical, pneumatic, hydraulic (e.g., using the liquid being sprayed), or electromechanical devices that are actuated with the pump 28 or are actuated independent of the pump 28.

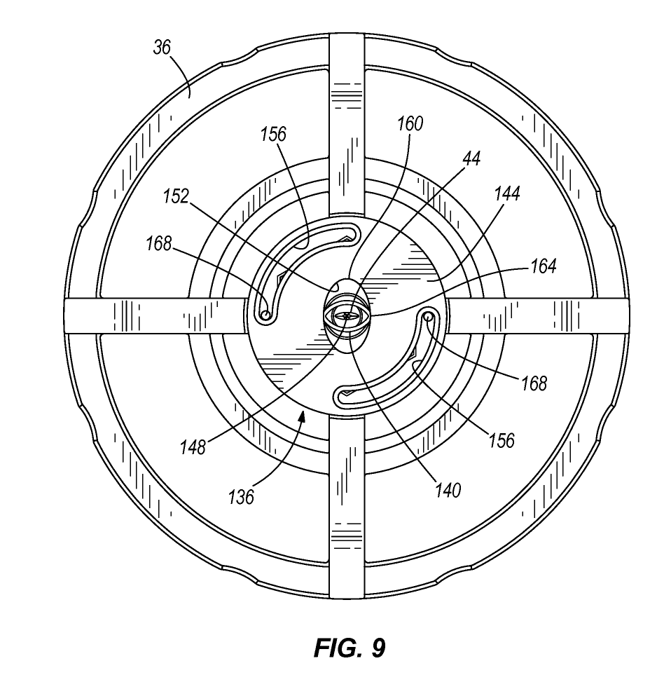

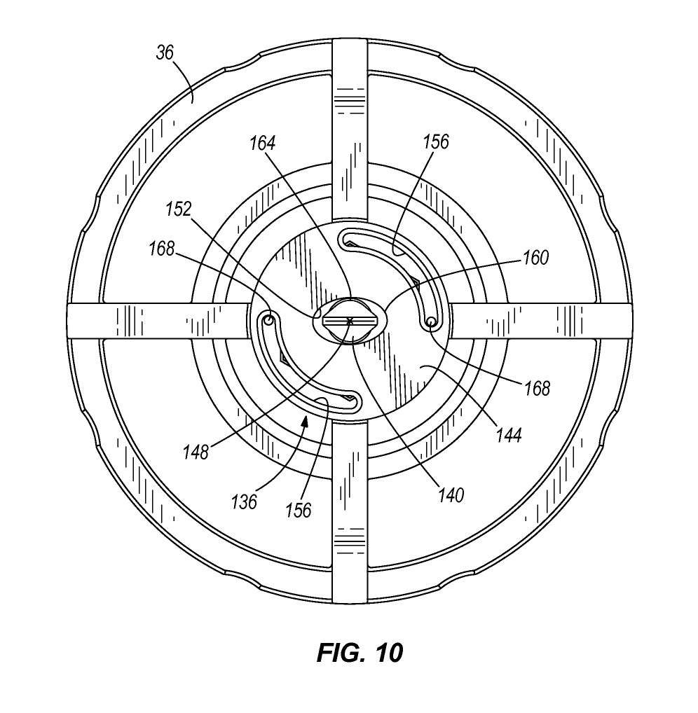

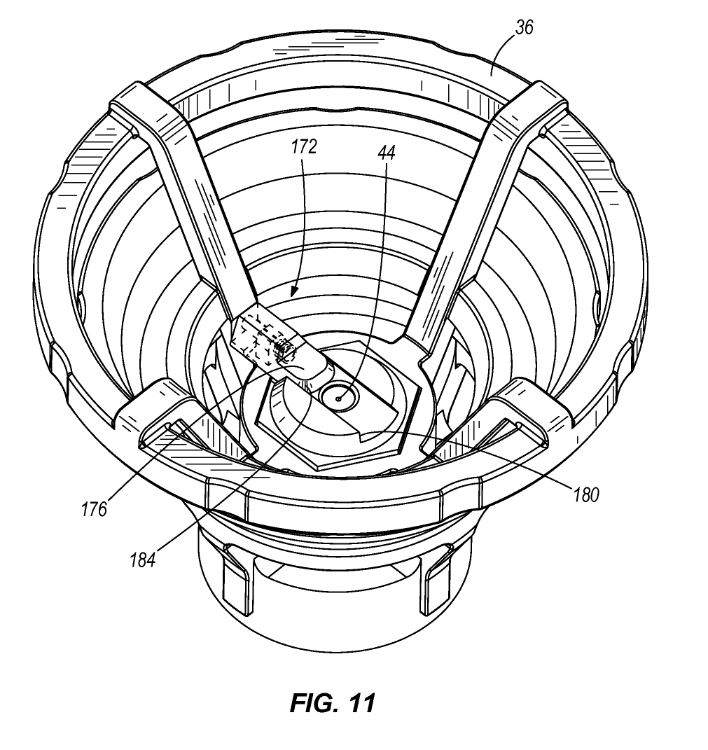

FIGS. 9 and 10 illustrate another nozzle closure device 136 that is suitable for use with the paint sprayer 20. The illustrated nozzle closure device 136 includes an elastomeric duckbill valve 140 (similar to the duckbill valve 64 shown in FIGS. 2A-3) and a rotatable disk 144. The duckbill valve 140 is movable between an open position (FIG. 9) and a closed position (FIG. 10) without removing the valve 140 from the body 24 of the paint sprayer 20. When in the open position, the duckbill valve 140 does not impinge on liquid being sprayed from the nozzle 44. When in the closed position, the duckbill valve 140 covers the nozzle 44 and inhibits liquid from curing in and around the nozzle 44. The elastomeric resilience of the duckbill valve 140 biases the valve 140 to the closed position.

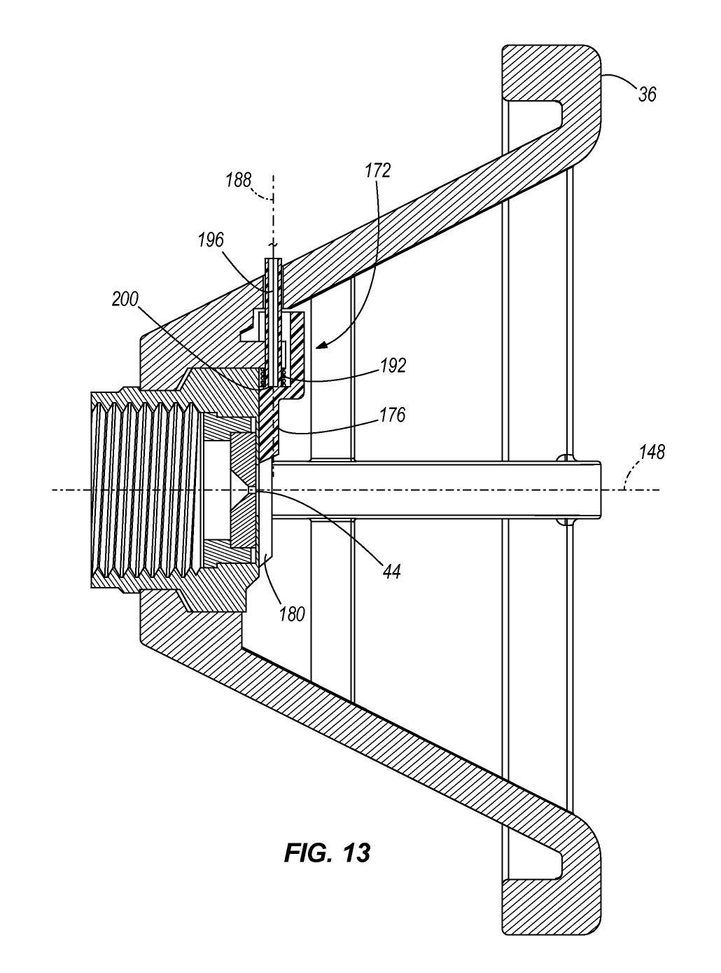

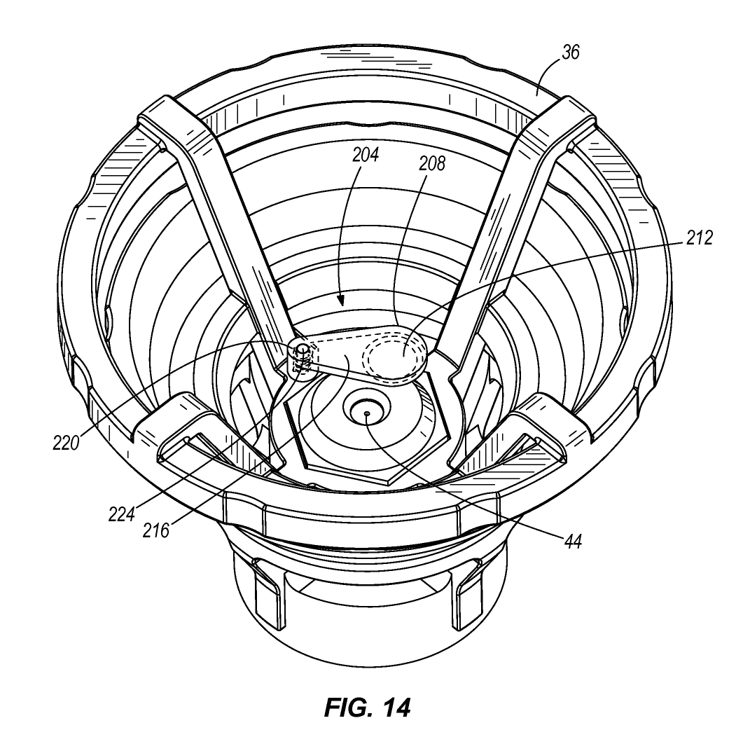

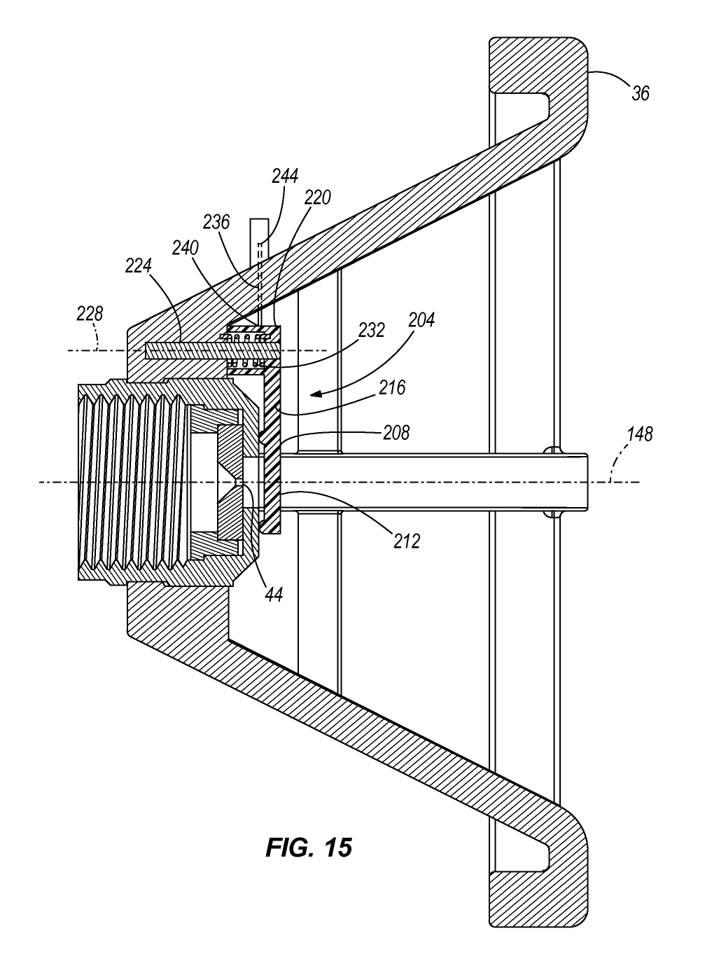

The disk 144 is coupled to the tip guard 36 adjacent the nozzle 44 and functions as an actuator mechanism. The illustrated disk 144 is rotatable about a nozzle axis 148 (see also FIGS. 13 and 15) defined by the nozzle 44 between a first rotational position (FIG. 9) and a second rotational position (FIG. 10). The first rotational position corresponds to the open position of the duckbill valve 140. The second rotational position corresponds to the closed position of the duckbill valve 140.

The rotatable disk 144 defines an elliptical opening 152 and two arcuate slots 156. The elliptical opening 152 has a greater dimension in one direction than in a perpendicular direction such that the opening 152 has a wide portion 160 and a narrow portion 164. The duckbill valve 140 extends through the opening 152. The arcuate slots 156 have constant and similar radii. Two pegs 168 are coupled to and extend outwardly from the tip guard 36. The pegs 168 extend through the slots 156 to limit the rotation of the disk 144 between the first and second rotational positions.

When in the first rotational position (FIG. 9), the disk 144 is rotated such that the pegs 168 are located at one end of the slots 156. In this position, the narrow portion 164 of the elliptical opening 152 compresses the duckbill valve 140 to move the valve 140 to the open position. When in the second rotational position (FIG. 10), the disk 144 is rotated such that the pegs 168 are located at another end of the slots 156. In this position, the wide portion 160 of the elliptical opening 152 provides clearance for the duckbill valve 140 so that the valve 140 can return to the closed position to cover the nozzle 44 and inhibit liquid from curing in and around the nozzle 44.

In the illustrated embodiment, the disk 144 is manually rotated between the first rotational position and the second rotational position. During use, a user manually rotates the disk 144 to the first rotational position to open the valve 140 and then operates the paint sprayer 20 by actuating the trigger 52. When finished, the user manually rotates the disk 144 to the second rotational position to cover the nozzle 44. In other embodiments, the disk 144 may be rotated between the first rotational position and the second rotational position automatically. For example, in some embodiments, the trigger 52 may cause the disk 144 to rotate between the positions. In such embodiments, the disk 144 may be moved by mechanical, pneumatic, hydraulic (e.g., using the liquid being sprayed), or electromechanical devices that are actuated with the pump 28 or are actuated independent of the pump 28.

In further embodiments, the duckbill valve 140 can be actively actuated to the closed position by a mechanism instead of relying on the natural resilience of the elastomeric material of the valve 140. In still further embodiments, rotation of the disk 144 can be constrained between the first and second rotational positions by a structure other than the illustrated slots 156 and pegs 168, or may be constrained by fewer or more slots and pegs. Additionally or alternatively, in some embodiments, the disk 144 can be biased toward one of the first and second positions. In such embodiments, the disk 144 can be maintained in the other of the first and second positions by a locking device (e.g., a latch, detents, etc.) when the paint sprayer 20 is in use (e.g., when the trigger 52 is actuated).

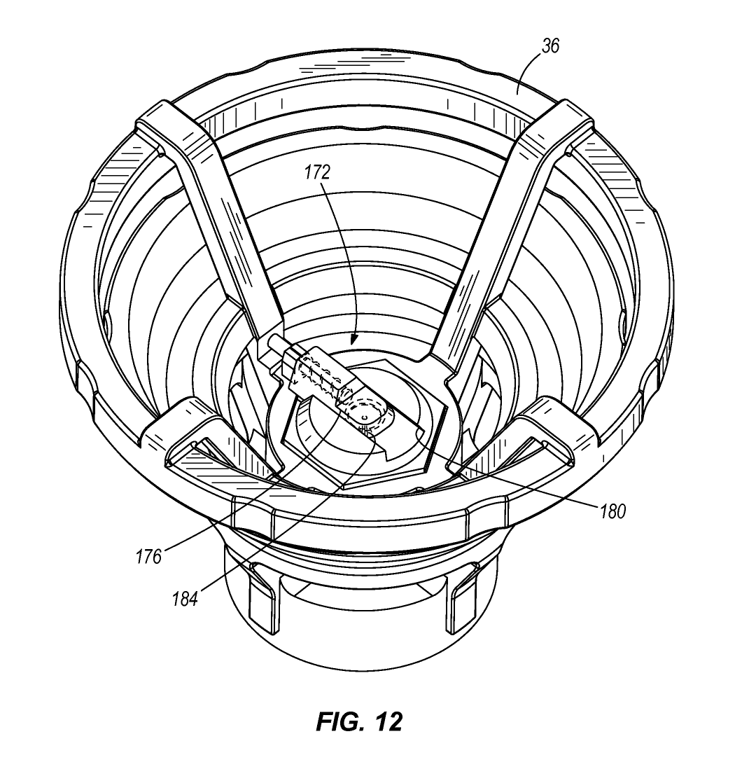

FIGS. 11-13 illustrate another nozzle closure device 172 that is suitable for use with the paint sprayer 20. The illustrated nozzle closure device 172 includes a cover 176 that is slidable within a track 180. The cover 176 and the track 180 are coupled to the tip guard 36 of the paint sprayer 20. The illustrated cover 176 includes a beveled edge 184 to facilitate movement within the track 180, but inhibit movement apart from and out of the track 180. The cover 176 is movable along an axis 188 (FIG. 13) between an open position (FIGS. 11 and 13) and a closed position (FIG. 12) without removing the cover 176 from the tip guard 36. When in the open position, the cover 176 is sufficiently spaced apart from the nozzle 44 so that the cover 176 does not impinge on liquid being sprayed from the nozzle 44. When in the closed position, the cover 176 is positioned over the nozzle 44 to cover the nozzle 44 and inhibit liquid from curing in and around the nozzle 44.

As shown in FIG. 13, the nozzle closure device 172 also includes a biasing member 192 and a shape memory component 196 that function as an actuator mechanism. In the illustrated embodiment, the biasing member 192 is a coil spring. In other embodiments, other suitable biasing members may also or alternatively be employed. The spring 192 is positioned between the cover 176 and a portion of the tip guard 36 to bias the cover 176 to the closed position.

The illustrated shape memory component 196 is, for example, a nickel-titanium FLEXINOL Shape Memory Alloy (SMA) wire manufactured by Dynalloy, Inc. The wire 196 has a first end 200 coupled to the cover 176 and a second end (not shown) coupled to a portion of the tip guard 36 or the body 24 of the paint sprayer 20. When heat is applied to the SMA wire 196, the wire 196 shrinks in length, pulling the cover 176 against the bias of the spring 192 from the closed position to the open position. In the illustrated embodiment, the SMA wire 196 is heated by applying an electrical current across the wire 196. The current used to heat the wire 196 may come from the paint sprayer 20 (e.g., from the power source used to power the pump 28) or from a separate power source.

When the trigger 52 of the paint sprayer 20 is actuated, an electrical current is applied to the SMA wire 196 to heat the wire 196, causing the wire 196 to shrink in length, overcome the bias of the spring 192, and slide the cover 176 to the open position. Actuating the trigger 52 also activates the pump 28 of the paint sprayer 20 to spray liquid from the nozzle 44. When the trigger 52 of the paint sprayer 20 is released, the paint sprayer 20 ceases to spray liquid from the nozzle 44 and removes the electrical current from the SMA wire 196. As the wire 196 cools, the wire 196 relaxes (i.e., expands in length), allowing the spring 192 to bias the cover 176 to the closed position to inhibit liquid from curing in and around the nozzle 44.

In other embodiments, the SMA wire 196 can be actuated by a device other than the trigger 52 such as, for example, a motion sensor. Additionally or alternatively, the cover 176 may be opened before the pump 28 is activated to spray liquid through the nozzle 44. For example, in some embodiments, actuating the trigger 52 a small amount can apply current to the SMA wire 196 before supplying power to the pump 28. The pump 28 may then be activated when the trigger 52 is completely actuated. In other embodiments, the cover 176 may be manually slid between the open and closed positions.

FIGS. 14-15 illustrate another nozzle closure device 204 that is suitable for use with the paint sprayer 20. Similar to the nozzle closure device 108 shown in FIGS. 7 and 8, the illustrated nozzle closure device 204 includes a pivot arm 208 having a sealing portion 212, an intermediate portion 216, and an attachment portion 220. The sealing portion 212 is shaped and sized to selectively cover the nozzle 44. A pin 224 extends through the attachment portion 220 to pivotally couple the pivot arm 208 to the tip guard 36. The arm 208 is thereby pivotable about an axis 228 defined by the pin 224 relative to the nozzle 44 between an open position (FIG. 14) and a closed position (FIG. 15) without removing the arm 208 from the tip guard 36.

When in the open position, the pivot arm 208 is pivoted about the axis 228 until the sealing portion 212 and the intermediate portion 216 are spaced apart from the nozzle 44 so that the arm 208 does not impinge on liquid being sprayed from the nozzle 44. When in the closed position, the pivot arm 208 is pivoted about the axis 228 until the sealing portion 212 is positioned over the nozzle 44 to cover the nozzle 44. In this position, the pivot arm 208 inhibits air from entering the nozzle 44 and curing liquid in and around the nozzle 44.

As shown in FIG. 15, the nozzle closure device 204 also includes a biasing member 232 and a shape memory component 236 that function as an actuator mechanism. In the illustrated embodiment, the biasing member 232 is a torsion spring. In other embodiments, other suitable biasing members may also or alternatively be employed. The spring 232 is positioned between the pivot arm 208 and the tip guard 36 and surrounds a portion of the pin 224 to bias the pivot arm 208 to the closed position.

The illustrated shape memory component 236 is, for example, a nickel-titanium FLEXINOL Shape Memory Alloy (SMA) wire manufactured by Dynalloy, Inc. The wire 236 has a first end 240 coupled to the pivot arm 208 and a second end 244 coupled to a portion of the tip guard 36. When heat is applied to the SMA wire 236, the wire 236 shrinks in length, pulling the pivot arm 208 against the bias of the spring 232 from the closed position to the open position. In the illustrated embodiment, the SMA wire 236 is heated by applying an electrical current across the wire 236. The current used to heat the wire 236 may come from the paint sprayer 20 (e.g., from the power source used to power the pump 28) or from a separate power source.

When the trigger 52 of the paint sprayer 20 is actuated, an electrical current is applied to the SMA wire 236 to heat the wire 236, causing the wire 236 to shrink in length, overcome the bias of the spring 232, and pivot the arm 208 to the open position. Actuating the trigger 52 also activates the pump 28 of the paint sprayer 20 to spray liquid from the nozzle 44. When the trigger 52 of the paint sprayer 20 is released, the paint sprayer 20 ceases to spray liquid from the nozzle 44 and removes the electrical current from the SMA wire 236. As the wire 236 cools, the wire 236 relaxes (i.e., expands in length), allowing the spring 232 to bias the pivot arm 208 to the closed position to inhibit liquid from curing in and around the nozzle 44.

In other embodiments, the SMA wire 236 can be coupled to the body 24 of the paint sprayer 20, rather than the tip guard 36. In addition, the SMA wire 236 can be actuated by a device other than the trigger 52 such as, for example, a motion sensor. Additionally or alternatively, the arm 208 may be pivoted open before the pump 28 is activated to spray liquid through the nozzle 44. For example, in some embodiments, actuating the trigger 52 a small amount can apply current to the SMA wire 236 before supplying power to the pump 28. The pump 28 may then be activated when the trigger 52 is completely actuated.

Although the invention has been described in detail with reference to certain preferred embodiments, variations and modifications exist within the scope and spirit of one or more independent aspects of the invention as described. Various features and advantages of the invention are set forth in the following claims.

1. A nozzle assembly for use with a paint sprayer, the paint sprayer including a reservoir configured to store a supply of liquid and a pump operable to draw liquid from the reservoir, the nozzle assembly comprising:
a nozzle configured to receive liquid under pressure from the pump and operable to spray the liquid onto a surface; and
a nozzle closure device that is movable between an open position, in which liquid is sprayed out of the nozzle generally unimpinged, and a closed position, in which the nozzle closure device covers the nozzle;
wherein the nozzle closure device is moved from the closed position to the open position by a force other than the liquid under pressure from the pump.

2. The nozzle assembly of claim 1, wherein the nozzle closure device is moved between the open position and the closed position without being removed from the paint sprayer.

3. The nozzle assembly of claim 1, wherein the nozzle closure device inhibits air from entering the nozzle when the nozzle closure device is in the closed position.

4. The nozzle assembly of claim 1, wherein the nozzle closure device includes a duckbill valve that is movable between the open position and the closed position.

5. The nozzle assembly of claim 4, further comprising an actuator mechanism coupled to the nozzle closure device, wherein the actuator mechanism moves the duckbill valve to the open position.

6. The nozzle assembly of claim 5, wherein the actuator mechanism includes a linkage that squeezes the duckbill valve to move the duckbill valve to the open position.

7. The nozzle assembly of claim 5, wherein the actuator mechanism includes a disk defining a generally elliptical opening, wherein the duckbill valve extends through the generally elliptical opening, and wherein the disk is rotated to move the duckbill valve to the open position.

8. The nozzle assembly of claim 1, wherein the nozzle closure device includes an arm, and wherein the arm is pivotable about an axis relative to the nozzle between the open position and the closed position.

9. The nozzle assembly of claim 8, wherein the nozzle closure device further includes a shape memory component, and wherein the shape memory component pivots the arm to the open position when heated.

10. The nozzle assembly of claim 1, wherein the nozzle closure device includes a cover, and wherein the cover is slidable along an axis relative to the nozzle between the open position and the closed position.

11. The nozzle assembly of claim 10, wherein the nozzle closure device further includes a shape member component, and wherein the shape memory component slides the cover to the open position when heated.

12. A paint sprayer comprising:
a body;
a nozzle supported by the body for spraying liquid onto a surface;
a reservoir configured to store a supply of liquid;
a pump operable to draw liquid from the reservoir and direct the liquid under pressure to the nozzle; and
a nozzle closure device coupled to the body adjacent the nozzle, the nozzle closure device movable between an open position, in which liquid is sprayed out of the nozzle generally unimpinged, and a closed position, in which the nozzle closure device covers the nozzle;
wherein the nozzle closure device is moved from the closed position to the open position by a force other than the liquid under pressure from the pump.

13. The paint sprayer of claim 12, wherein the nozzle closure device is moved between the open position and the closed position without being removed from the body.

14. The paint sprayer of claim 12, wherein the nozzle closure device inhibits air from entering the nozzle when the nozzle closure device is in the closed position.

15. The paint sprayer of claim 12, further comprising a trigger supported by the body, wherein the trigger is actuated to activate the pump, and wherein the trigger is also actuated to move the nozzle closure device to the open position.

16. The paint sprayer of claim 12, wherein the nozzle closure device includes a duckbill valve that is movable between the open position and the closed position.

17. The paint sprayer of claim 16, further comprising an actuator mechanism coupled to the nozzle closure device, wherein the actuator mechanism moves the duckbill valve to the open position.

18. The paint sprayer of claim 17, wherein the actuator mechanism includes a linkage that squeezes the duckbill valve to move the duckbill valve to the open position.

19. The paint sprayer of claim 17, wherein the actuator mechanism includes a disk defining a generally elliptical opening, wherein the duckbill valve extends through the generally elliptical opening, and wherein the disk is rotated to move the duckbill valve to the open position.

20. The paint sprayer of claim 12, wherein the nozzle closure device includes an arm, and wherein the arm is pivotable about an axis relative to the nozzle between the open position and the closed position.

21. The paint sprayer of claim 20, wherein the nozzle closure device further includes a shape memory component, and wherein the shape memory component pivots the arm to the open position when heated.

22. The paint sprayer of claim 12, wherein the nozzle closure device includes a cover, and wherein the cover is slidable along an axis relative to the nozzle between the open position and the closed position.

23. The paint sprayer of claim 22, wherein the nozzle closure device further includes a shape member component, and wherein the shape memory component slides the cover to the open position when heated.

24. The paint sprayer of claim 12, wherein the body includes a handle, and wherein the pump and the reservoir are supported by the body.
